(19) United States
(12) Patent Application Publication
(10) Pub. No.: US 2014/0064909 A1
(43) Pub. Date: Mar. 6, 2014

(54) SEAL DESIGN AND ACTIVE CLEARANCE CONTROL STRATEGY FOR TURBOMACHINES

(71) Applicants: Deepak Trivedi, Schenectady, NY (US); Norman Arnold Turnquist, Carlisle, NY (US); Xiaoqing Zheng, Niskayuna, NY (US); Murat Inalpolat, Clifton Park, NY (US)

(72) Inventors: Deepak Trivedi, Schenectady, NY (US); Norman Arnold Turnquist, Carlisle, NY (US); Xiaoqing Zheng, Niskayuna, NY (US); Murat Inalpolat, Clifton Park, NY (US)

(73) Assignee: GENERAL ELECTRIC COMPANY, Schenectady, NY (US)

(21) Appl. No.: 13/596,386

(22) Filed: Aug. 28, 2012

(51) Int. Cl. F01D 11/02; F16J 15/447

(52) U.S. Cl. 415/1; 277/413; 415/173.5

(57) ABSTRACT

A labyrinth seal design, an actuation control clearance strategy, and a method of operating a turbomachine. The labyrinth seal design including a plurality of features configured to open and close radial clearances in response to relative axial movement between a stationary component and a rotating component. The actuation control clearance strategy and method of operating a turbomachine effective to achieve relative motion between a rotating component and a stationary component of the turbomachine using active elements. Axial displacement of the rotating component relative to the stationary component provides an adjustment in a radial clearance at one or more sealing locations between the rotating component and the stationary component to suit a given operating condition of the turbomachine.

### BACKGROUND

Embodiments presented herein relate generally to seals for rotary machines such as steam and gas turbines and particularly relates to a labyrinth seal design and an active clearance control actuation strategy for active clearance control and span reduction in turbomachines.

Rotary machines, and more particularly, turbomachines, such as steam and gas turbines, used for power generation and mechanical drive applications, are generally large machines consisting of multiple turbine stages. In turbines, high pressure fluid flowing through the turbine stages must pass through a series of stationary and rotating components, and seals between the stationary and rotating components are used to control leakage. The efficiency of the turbine is directly dependent on the ability of the seals to prevent leakage, e.g., between the rotor and stator. Turbine designs are conventionally classified as either impulse, with the majority of the pressure drop occurring across fixed nozzles, or reaction, with the pressure drop more evenly distributed between the rotating and stationary vanes. Both designs may employ rigid tooth, i.e., labyrinth seals to control leakage. Traditionally, rigid labyrinth seals of either a hi-lo or straight shaft design are used. These types of seals are employed at virtually all turbine locations where leakage between rotating and stationary components must be controlled. This includes interstage shaft seals, rotor end seals, and bucket (or blade) tip seals. Steam turbines of both impulse and reaction designs typically employ rigid, sharp teeth for rotor/stator sealing. While labyrinth seals have proved to be quite reliable, their performance degrades over time as a result of transient events in which the stationary and rotating components interfere, rubbing the labyrinth teeth into a “mushroom” profile and opening the seal clearance.

In an attempt to prevent such rub failures, resulting in an increased probability of seal leakage, labyrinth seal designs may incorporate radial and axial clearances to prevent rubs during transients. These clearances, while decreasing the likelihood of seal leakage, may decrease efficiency and increase machine footprint. Several passive and active approaches for clearance control exist for turbomachines. Many of these approaches are passive thermal-based and slow to respond to transients, and therefore limit the operational flexibility of the machine. State-of-the-art active approaches are typically based on a cone-in-cone concept and do not optimize clearances throughout. Other seal technologies for performance improvement include advanced seals such as brush seals, compliant plate seals and abradables that in many applications may be cost prohibitive.

In light of the above, it is desired to provide an improved labyrinth seal design and an actuation control clearance strategy for active clearance control and span reduction in turbomachines.

### BRIEF SUMMARY

These and other shortcomings of the prior art are addressed by the present disclosure, which provides a labyrinth seal design for a turbomachine. The labyrinth seal design comprising a plurality of features configured to open and close radial clearances in response to relative axial movement between a stationary component and a rotating component.

In accordance with an exemplary embodiment of the present disclosure, provided is an actuation control clearance strategy to effect relative motion between at least one rotating component and at least one stationary component of a turbomachine using active elements. The actuation control clearance strategy comprising: providing a stationary component having an inner wall and a rotating component positioned relative to the stationary component, the rotating component forming a radial clearance at one or more sealing locations between the rotating component and the inner wall; providing at least one labyrinth seal including a plurality of features configured to open and close the radial clearance at a sealing location of the one or more sealing locations in response to relative axial movement between the stationary component and the rotating component; and axially displacing the rotating component relative to the stationary component, thereby adjusting the radial clearance at the one or more sealing locations between the rotating component and the inner wall to suit a given operating condition of the turbomachine.

In accordance with an exemplary embodiment of the present disclosure, provided is a method of operating a turbomachine. The method of operating a turbomachine comprising providing a turbomachine with a stationary component having an inner wall and a rotating component positioned relative to the stationary component, the rotating component carrying a plurality of blades each having a blade tip facing towards the inner wall and forming a radial clearance between each blade tip and the inner wall; providing a labyrinth seal including a plurality of features configured to open and close the radial clearance in response to relative axial displacement between the stationary component and the rotating component; and axially displacing the rotating component relative to the stationary component, thereby adjusting the radial clearance between the blade tip and the inner wall to suit a given operating condition of the turbomachine.

Other objects and advantages of the present disclosure will become apparent upon reading the following detailed description and the appended claims with reference to the accompanying drawings.

### BRIEF DESCRIPTION OF THE FIGURES

The above and other features, aspects, and advantages of the present disclosure will become better understood when the following detailed description is read with reference to the accompanying drawings in which like characters represent like parts throughout the drawings, wherein:

FIG. 1 is a diagrammatic illustration of an engine, in accordance with aspects disclosed herein;

FIG. 2 is a diagrammatical illustration of a prior art labyrinth seal;

FIG. 3 is a diagrammatical illustration of a seal design and active clearance control strategy in accordance with an embodiment;

FIG. 4 is an enlarged diagrammatical illustration of a portion of a seal design and active clearance control strategy as assembled in accordance with an embodiment;

FIG. 5 is an enlarged diagrammatical illustration of a portion of a seal design and active clearance control strategy of FIG. 4 subsequent to rotor actuation in accordance with an embodiment;

FIG. 6 is an enlarged diagrammatical illustration of a portion of the seal design and active clearance control strategy of FIG. 4 during steady state actuation in accordance with an embodiment;

FIG. 7 is a diagrammatical illustration of variations of the seal design and active clearance control strategy of FIG. 4-6 during varying states of actuation in accordance with embodiments;

FIG. 8 is an enlarged diagrammatical illustration of a portion of a seal design and active clearance control strategy as assembled in accordance with another embodiment;

FIG. 9 is an enlarged diagrammatical illustration of a portion of a seal design and active clearance control strategy of FIG. 8 subsequent to rotor actuation in accordance with an embodiment;

FIG. 10 is an enlarged diagrammatical illustration of a portion of the seal design and active clearance control strategy of FIG. 8 during steady state actuation in accordance with an embodiment;

FIG. 11 is a diagrammatical illustration of variations of the seal design and active clearance control strategy of FIG. 8-10 during varying states of actuation in accordance with embodiments;

FIG. 12 is an exemplary graphical representation illustrating the effect of actuator displacement as it relates to the actuation profile of a seal design and active clearance control strategy in accordance with an embodiment;

FIG. 13 is an exemplary graphical representation illustrating the benefits achieved with use of the seal design and active clearance control strategy in accordance with an embodiment; and

FIG. 14 is a schematic block diagram of an actuation control clearance strategy, or method or operating a turbomachine, according to an exemplary embodiment.

### DETAILED DESCRIPTION

One or more specific embodiments of the present apparatus will be described below. In an effort to provide a concise description of these embodiments, not all features of an actual implementation are described in the specification.

Embodiment disclosed herein relate to labyrinth seal designs and more particularly to labyrinth seal designs and an actuation control clearance strategy for active clearance control and span reduction in turbomachines, such as turboengines, steam turbines, or the like. As used herein, the labyrinth seal design is applicable to various types of turbomachinery applications such as, but not limited to, turbojets, turbo fans, turbo propulsion engines, aircraft engines, gas turbines, steam turbines, wind turbines, and water turbines. In addition, as used herein, singular forms such as “a”, “an”, and “the” include plural referents unless the context clearly dictates otherwise.

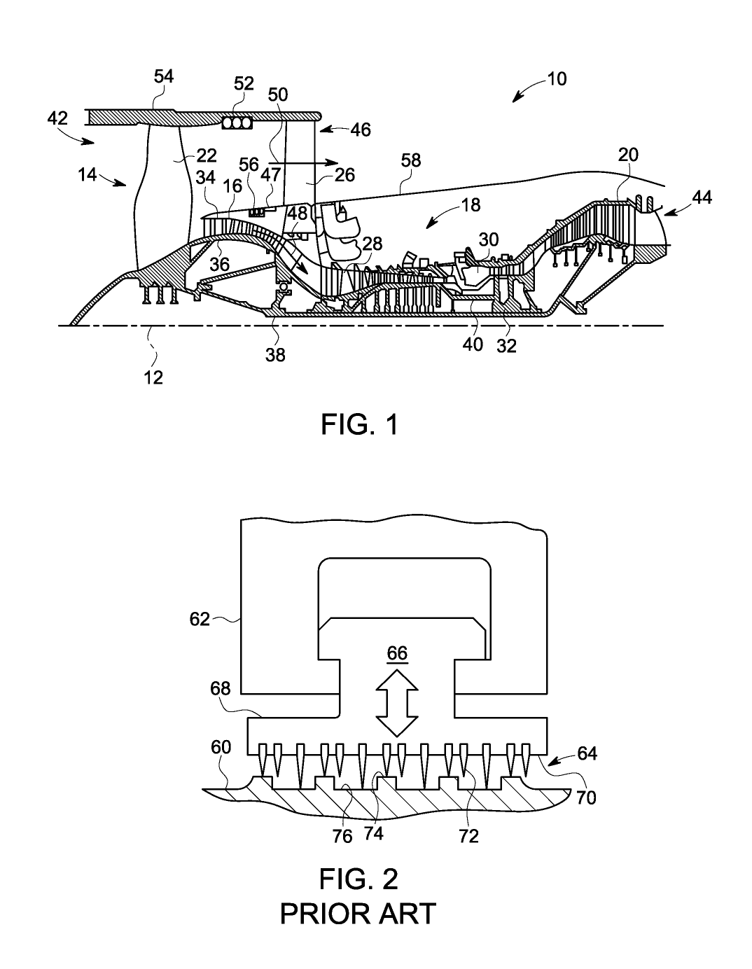

Referring now to the drawings, in which like numerals refer to like elements throughout the several views, FIG. 1 is a schematic illustration of an exemplary aircraft engine assembly 10 in accordance with the present disclosure. Reference numeral 12 may be representative of a centerline axis 12. In the exemplary embodiment, the engine assembly 10 includes a fan assembly 14, a booster compressor 16, a core gas turbine engine 18, and a low-pressure turbine 20 that may be coupled to the fan assembly 14 and the booster compressor 16. The fan assembly 14 includes a plurality of rotor fan blades 22 that extend substantially radially outward from a fan rotor disk 24, as well as a plurality of outlet guide vanes 26 that may be positioned downstream of the rotor fan blades 22. The core gas turbine engine 18 includes a high-pressure compressor 28, a combustor 30, and a high-pressure turbine 32. The booster compressor 16 includes a plurality of rotor blades 34 that extend substantially radially outward from a compressor rotor disk 36 coupled to a first drive shaft 38. The high-pressure compressor 28 and the high-pressure turbine 32 are coupled together by a second drive shaft 40. The engine assembly 10 also includes an intake side 42, a core engine exhaust side 44, and a fan exhaust side 46.

During operation, the fan assembly 14 compresses air entering the engine 10 through the intake side 42. The airflow exiting the fan assembly 14 is split such that a portion 48 of the airflow is channeled into the booster compressor 16, as compressed airflow, and a remaining portion 50 of the airflow bypasses the booster compressor 16 and the core gas turbine engine 18 and exits the engine 10 through the fan exhaust side 46 as bypass air. This bypass air portion 50 flows past and interacts with the outlet guide vanes 26 creating unsteady pressures on the stator surfaces as well as in the surrounding airflow that radiate as acoustic waves. The plurality of rotor blades 40 compress and deliver the compressed airflow 48 towards the core gas turbine engine 18. Furthermore, the airflow 48 is further compressed by the high-pressure compressor 28 and is delivered to the combustor 30. Moreover, the compressed airflow 48 from the combustor 30 drives the rotating high-pressure turbine 32 and the low-pressure turbine 20 and exits the engine 10 through the core engine exhaust side 44.

As previously noted, seals are employed at virtually all turbine locations where leakage between rotating and stationary components must be controlled, such as for example between rotors and stators, such as rotors 40 and stators 26 of FIG. 1. Referring more particularly to FIG. 2, there is illustrated a portion of a prior art rotary machine, for example, a turbine, having a turbine shaft 60 disposed in a turbine housing 62 and which shaft 60 is supported by conventional means, not shown, within turbine housing 62, such as known in the art. A labyrinth seal, generally designated 64, disposed between the rotating shaft 60 and the stationary housing 62, includes a seal ring 66 disposed about the shaft 60 separating high and low pressure regions on axially opposite sides of the ring. It will be appreciated that while only one seal 64 is disclosed, typically multiple-stage labyrinth seals are provided about rotor shafts. Each seal ring 66 is formed of an annular array of a plurality of arcuate seal elements 68 having sealing faces 70 and a plurality of radially projecting, axially spaced teeth 72. The teeth 72 are of a hi-lo design for obtaining close clearances with the radial projections or ribs 74 and the grooves 76 of the shaft 60. The labyrinth seal functions by placing a relatively large number of barriers, i.e., the teeth, to the flow of fluid from a high pressure region to a low pressure region on opposite sides of the seal 64, with each barrier forcing the fluid to follow a tortuous path whereby pressure drop is created. The sum of the pressure drops across the labyrinth seal 64 is by definition the pressure difference between the high and low pressure regions on axially opposite sides thereof. These labyrinth seal ring segments 66 are typically spring-backed and thus may be free to move radially, as indicated by the directional arrow, when subjected to severe rotor/seal interference. In certain designs, the springs maintain the seal ring segments 66 radially outwardly away from the rotor, for example, during startup and shutdown, with fluid pressure being supplied between the seal rings segments 66 and the rotor housing to displace the seal ring segments 66 radially, and more particularly in an inwardly direction, to obtain a lesser clearance with the rotor, i.e., close the seals, after the rotor has been brought up to speed. As illustrated, the labyrinth seal 64 when under the influence of radial movement provides radial clearances, between the rotating shaft 60 and the stationary housing 62, to open and close as required.

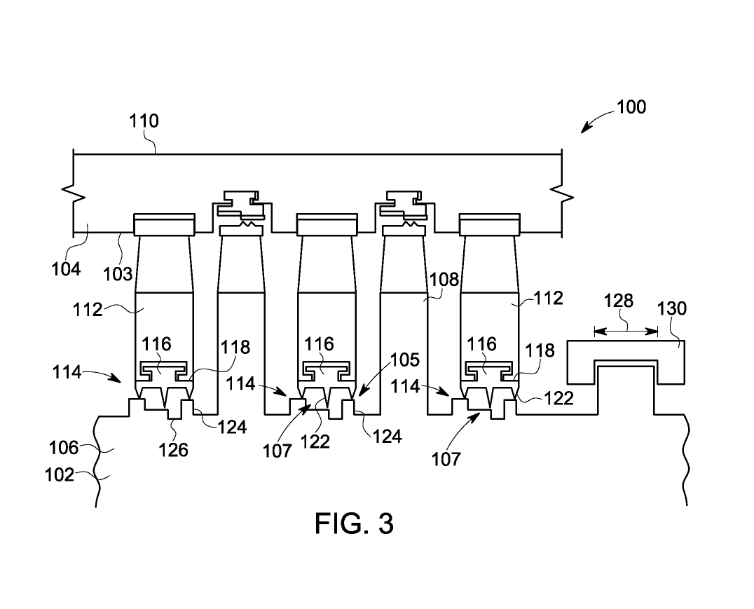

Referring to FIG. 3, there is illustrated a portion of a rotary machine 100, for example, a turbine, in accordance with an embodiment including the novel seal design and active clearance control strategy as disclosed herein. Rotary machine 100 includes a rotating component 102 and a stationary component 104. In an embodiment, the rotating component 102 may be a turbine rotor 106 having a plurality of rotor blades 108 extending therefrom and supported by conventional means, not shown, such as known in the art. In an embodiment, the stationary component 104 may be a stator 110, including a plurality of stator vanes 112, extending therefrom and supported by conventional means, not shown, such as known in the art. In an embodiment, the stationary component 104 may include an inner wall 103. The rotating component 102 is positioned relative to the stationary component 104 to form a radial clearance 105 at one or more sealing locations 107 between the rotating component 102 and the inner wall 103.

A labyrinth seal, generally designated 114, is disposed between the rotor 106 and each of the stationary stator vanes 110. The labyrinth seal 114, includes a seal ring 116 disposed proximate the rotor 106 separating high and low pressure regions on axially opposite sides of the seal ring 116. It will be appreciated that as illustrated, typically multiple-stage labyrinth seals are provided proximate the rotating component 102, and more particularly the rotor 106. Each seal ring 116 is formed of an annular array of a plurality of arcuate seal elements 118 having sealing faces 120 and a plurality of radially projecting, axially spaced teeth 122. As illustrated, in an embodiment, the teeth 122 are of a hi-lo design for obtaining close clearances with a plurality of radial projections or ribs 124 and the grooves 126 of the rotating element 102. The labyrinth seal 114 functions by placing a relatively large number of barriers, i.e., the teeth, to the flow of fluid from a high pressure region to a low pressure region on opposed sides of the seal 114, with each barrier forcing the fluid to follow a tortuous path whereby pressure drop is created. The sum of the pressure drops across each of the labyrinth seals 114 is by definition the pressure difference between the high and low pressure regions on axially opposite sides thereof. The rotor 102 is free to move axially, as indicated by the directional arrow 128, during operation. During operation, as the rotating component 102, and more particularly rotor 106 heats up, it “grows” in an axial direction, so as to be displaced away from an active thrust bearing 130. The axial motion of the rotor 102 is controlled by an actuator (not shown) and is relative to growth of the rotor 102 axially to the active thrust bearing 130. The novel labyrinth seal design (described in greater detail below) when under the influence of this axial displacement provides radial clearances, between the rotating component 102 and the stationary component 104, to open and close as required.

In accordance with one embodiment, and as previously described, the novel labyrinth seal design and active clearance control strategy disclosed herein provides an axial degree of freedom to a rotating component, thereby providing for adjustment of radial clearances provided between the rotating component and the stationary component as required. In general, the components of the labyrinth seal, e.g., the teeth and cooperating ribs and grooves, may be formed on either the rotating component or the static component. For example for the seals between a rotor blade tip and the stator, the teeth are typically formed on the stator, but for the seals between the nozzle and the rotor, the teeth are typically formed on the rotor. In yet another alternate embodiment, the teeth and/or cooperating ribs and grooves may be formed on both the rotor and stator. The location of the ribs and the grooves is designed such that the same rotor actuation opens or closes the clearances for all seals regardless of whether the teeth are on the rotating component or the static component.

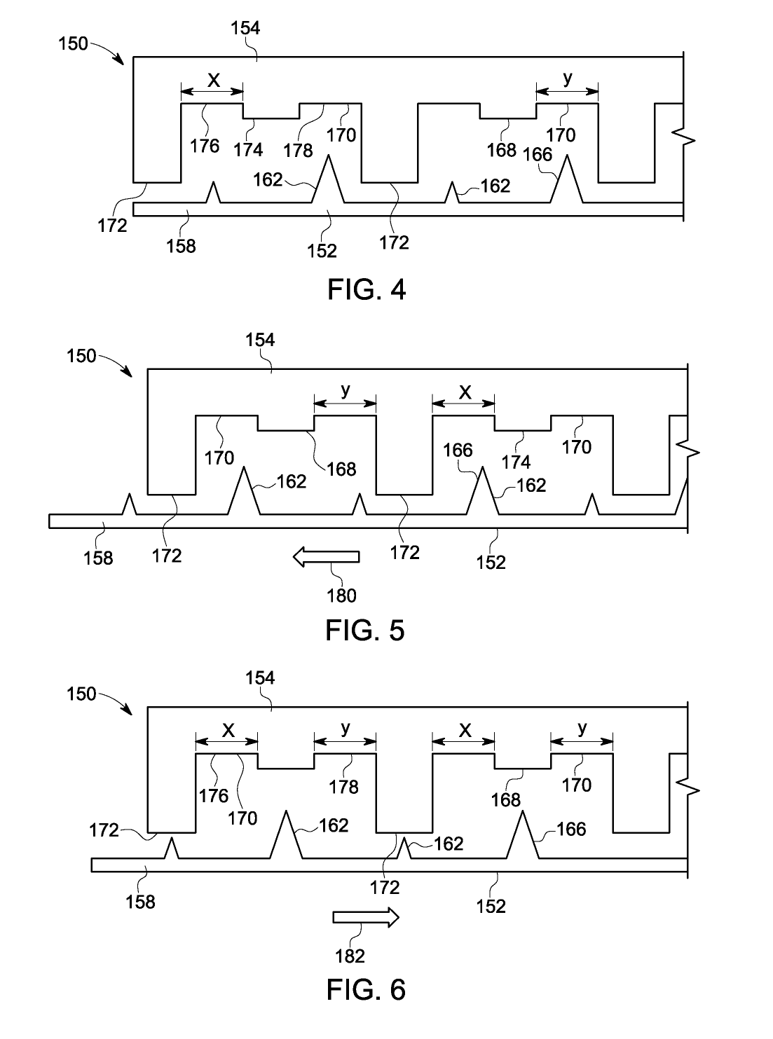

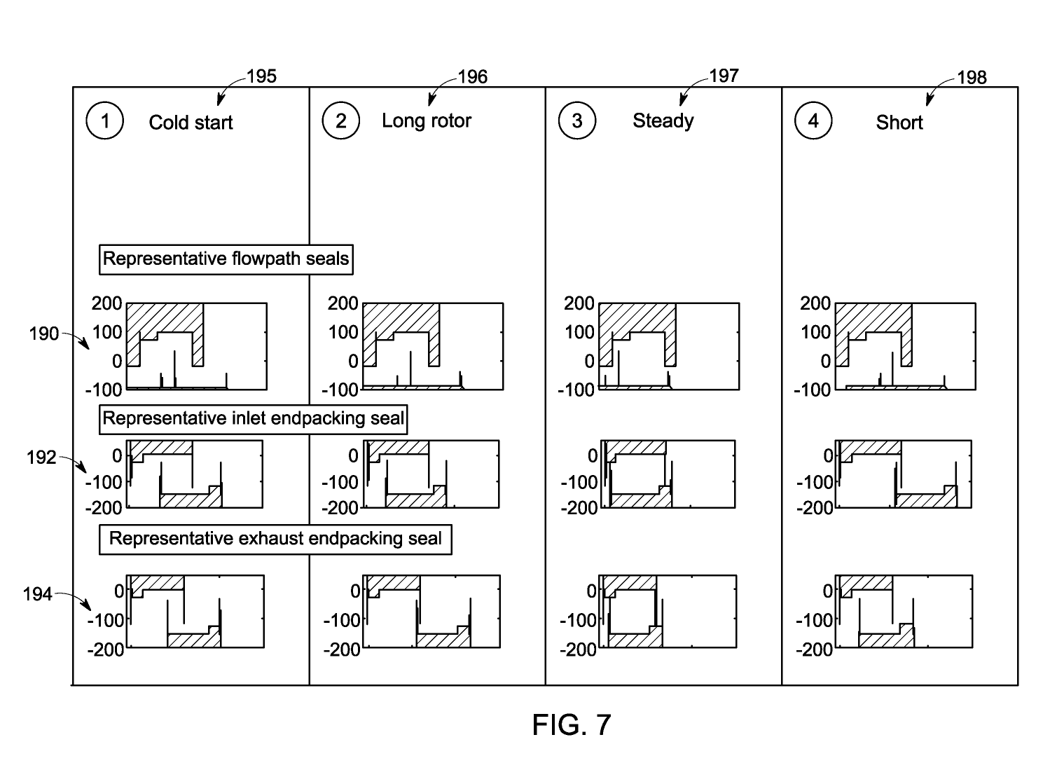

Referring now to FIGS. 4-11, illustrated are enlarged diagrammatical illustrations of portions of a plurality of labyrinth seal designs and active clearance control strategies in accordance with embodiments disclosed herein. As previously noted, like numerals refer to like elements throughout the several views. Referring more specifically to FIGS. 4-6, illustrated is a novel labyrinth seal design generally designated 150 during stages of engine operation. In this particular embodiment, illustrated are a rotating component 152 and a stationary component 154, generally similar to rotating component 102 and stationary component 104 of FIG. 3. In an embodiment, the rotating component 152 is a rotor, and the stationary component 154 is a stator. The rotating component 152 includes an arcuate seal element 158 including a plurality of radially projecting axially spaced teeth 162, generally similar to teeth 122 of FIG. 3. The teeth 162, as previously described, are of hi-low design and include a plurality of long teeth 164 and a plurality of short teeth 166. In addition, the stationary component 154 has provided therein a plurality of radially projecting ribs, or lands, 168, and a plurality of grooves, or pockets, 170, generally similar to the ribs 124 and the grooves 126, of FIG. 3. In this particular embodiment, the ribs 168 are of varying height, and include alternating plurality of long ribs 172 and short ribs 174. The long and short ribs 172, 174 having spaced therebetween the plurality of grooves, or pockets, 170. More specifically, in the illustrated embodiment, the labyrinth seal 150 is configured including a first groove 176 and a second groove 178 disposed between each pair of long ribs 172 and having a short rib 174 disposed therebetween the first groove 176 and the second groove 178. In an alternate embodiment, such as at turbine endpacking location (as best illustrated in FIG. 7), the plurality of long ribs 172 and short ribs 174 may be configured in a non-alternating relationship.

Referring again to FIGS. 4-6, the dimensions of the plurality of ribs 168 and grooves, or pockets, 170 are designed throughout the turbomachine to enable proper positioning of the plurality of radially projecting axially spaced teeth 162 throughout the turbomachine. More particularly, in the embodiment illustrated in FIGS. 4-6, the grooves 170, and more particularly the first groove 176 and the second groove 178, each have an axial dimensional width “x” and “y”, respectively, wherein “x” is greater than zero (x>0) and “y” is greater than zero (y>0). In an embodiment, “x” may be equal to “y” (x=y). In an alternate embodiment, “x” may not be equal to “y” (x≠y). In addition, proper positioning of the plurality of radially projecting axially spaced teeth 162 is achieved by controlling the axial position of the rotating component 152 using “N” actuations appropriately spaced in time (with N in a range of 1 to infinity, infinity being in the limiting case of continuous actuation).

In the illustrated embodiment, the actuation control clearance strategy requires each of the long teeth 166 and the short teeth 164 to be located in or aligned with a groove 170 during the transients, i.e. engine stop/starts as best illustrated in FIG. 4. Subsequent to actuation of the rotating component 152, the rotating component 152 undergoes thermal expansion, as illustrated in FIG. 5. During this state of operation the rotating component 152 expands, also referred to herein as lengthening or growing, in an axial direction relative to a thrust bearing, as indicated by axial directional arrow 180. During this stage, the rotating component 152 is at its longest relative to the stationary component 154. When steady state engine operation is achieved, as illustrated in FIG. 6, the rotating component 152, having grown or lengthened axially relative to the stationary component 154, is adjusted axially, as indicated by axial directional arrow 182, to “close” the clearances formed therebetween the rotating component 152 and the stationary component 154. This axial adjustment of the rotating component 152 positions each of the short teeth 164 in alignment with one of the long ribs 172 and each of the long teeth 166 in alignment with one of the short ribs 174, thereby closing the radial clearances between the rotating component 152 and the stationary component 154.

Referring now to FIG. 7, illustrated are configurations of varying seal designs, and more particularly a design representative of a flowpath seal 190, an inlet endpacking seal 192 and an exhaust endpacking seal 194, each showing seal configuration during varying states of operation, including cold start 195, long rotor, 196, steady 197 and short rotor 198. More specifically, illustrated is a flowpath seal 190, such as that previously described. In addition, illustrated are endpacking seals 192 and 194 in which the plurality of long ribs, such as long ribs 172 and short ribs, such as short ribs 174, may be configured in a non-alternating relationship. In addition, the teeth and/or cooperating ribs and grooves may be formed on both the rotating and stationary components. In the illustrated configurations, a smaller actuation stroke is required than that of an asymmetric design (described presently). This may result in a greater margin of actuation error.

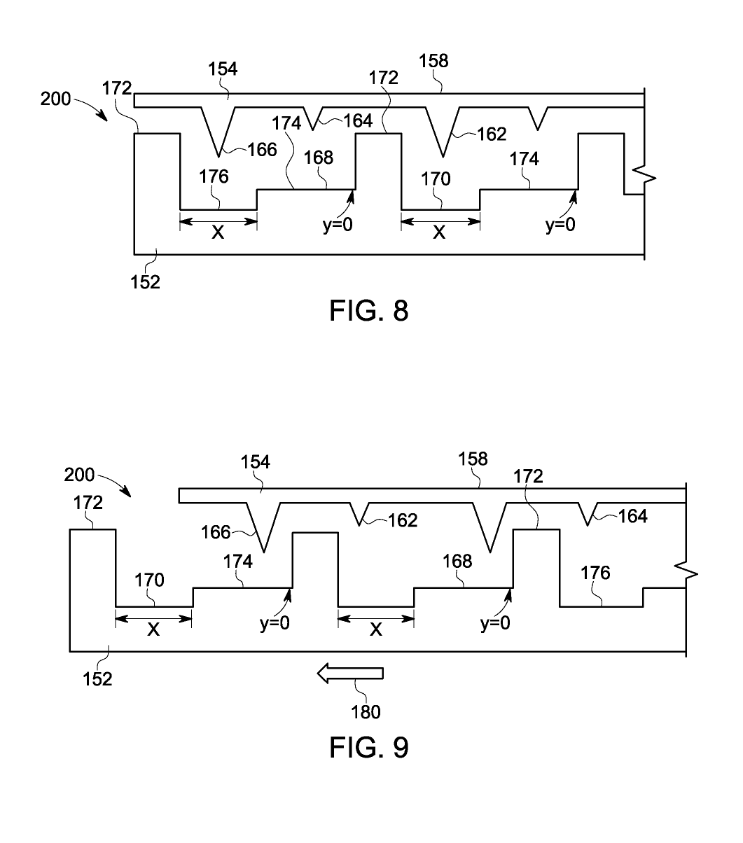

Referring now to FIGS. 8-11, illustrated are enlarged diagrammatical illustrations of portions of a labyrinth seal design and active clearance control strategies in accordance with another embodiment. More specifically illustrated is a novel labyrinth seal design generally designated 200 during stages of engine operation. As previously noted, like elements are designated with like numbers throughout the disclosed embodiments. In this particular embodiment, illustrated are a rotating component 152 and a stationary component 154, generally similar to rotating component 102 and stationary component 104 of FIG. 3. In the illustrated embodiment, and in contrast to the previous embodiment illustrated in FIGS. 4-7, the stationary component 154 includes an arcuate seal element 158, including a plurality of radially projecting axially spaced teeth 162, generally similar to teeth 122 of FIG. 3. The teeth 162, as previously described, are of hi-low design and include a plurality of long teeth 164 and a plurality of short teeth 166. In addition, the rotating component 152 has provided therein a plurality of radially projecting ribs, or lands, 168, and a plurality of grooves, or pockets, 170, generally similar to the ribs 124 and the grooves 126, of FIG. 3. In this particular embodiment, the ribs 168 are of varying height, and include alternating plurality of long ribs 172 and short ribs 174. The long and short ribs 172, 174 having spaced therebetween the plurality of grooves, or pockets, 170.

As previously indicated, the dimensions of the plurality of ribs 168 and grooves 170 and are designed throughout the turbomachine to enable proper positioning of the plurality of radially projecting axially spaced teeth 162 throughout the turbomachine. More particularly, in the embodiment illustrated in FIGS. 8-10, the grooves 170, and more particularly a first groove 176 has an axial dimensional width “x”, wherein “x” is greater than zero (x>0). A second groove is described as disposed generally similar to the embodiment described with regard to FIGS. 4-6, but having an axial dimensional width “y” of zero. Accordingly, the second groove is not visible, as shown in the illustrated embodiment. More specifically, in the illustrated embodiment, the labyrinth seal 200 is configured including a first groove 176 disposed between each pair of long ribs 172 and having a short rib 174 disposed therebetween the first groove 176 and the second groove, wherein the second groove has an axial dimensional width “y” of zero. Alternatively, the embodiment may be described as including a single groove 176 disposed between each of the long ribs 172 and the short ribs 174, wherein each of the long teeth 162 is aligned with the groove 176 during a transient state (described presently) resulting in an asymmetric seal design. In addition, proper positioning of the plurality of radially projecting axially spaced teeth 162 is achieved by controlling the axial position of the rotating component 152 using “N” actuations appropriately spaced in time (with N in a range of 1 to infinity, infinity being in the limiting case of continuous actuation).

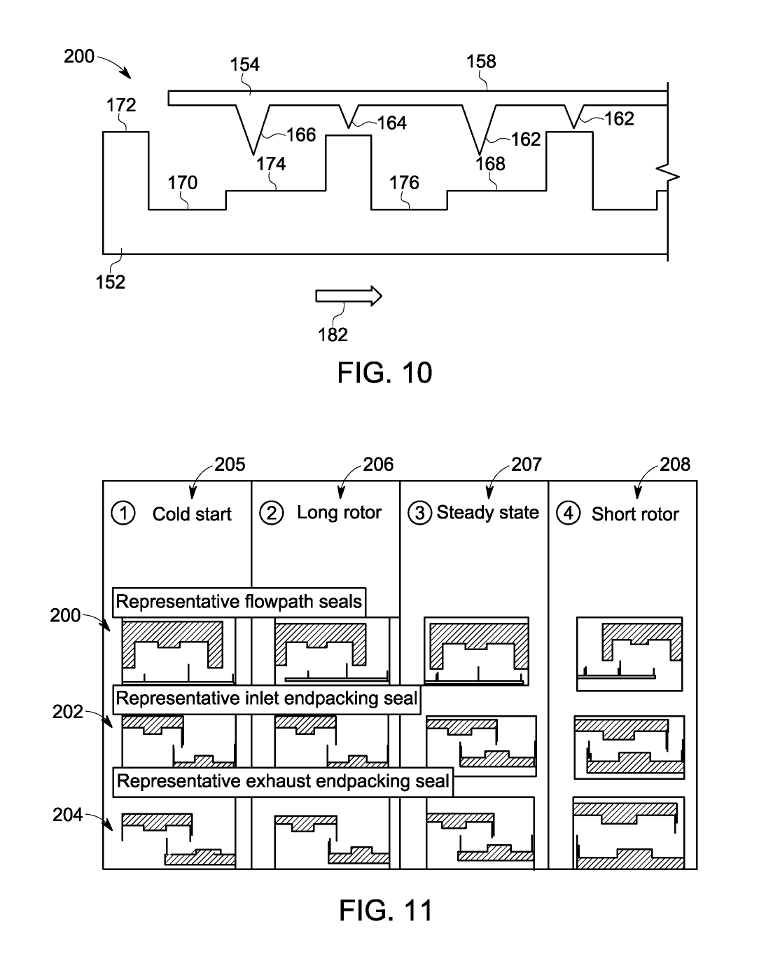

In the illustrated embodiment, the actuation control clearance strategy is generally similar to that previously described with regard to FIGS. 4-7, but in contrast requires each of the long teeth 166 to be located in or aligned with one of the plurality of grooves 170 and the short teeth 164 to be aligned with a short rib 174 during the transients, i.e. engine stop/starts as best illustrated in FIG. 8. Subsequent to actuation of the rotating component 152, the rotating component 152 undergoes thermal expansion, as illustrated in FIG. 9. During this state of operation the rotating component 152 expands, thus lengthening or growing, in an axial direction relative to a thrust bearing, as indicated by axial directional arrow 180. During this stage, the rotating component 152 is at its longest relative to the stationary component 154. When steady state engine operation is achieved, as illustrated in FIG. 10, the rotating component 152, having grown or lengthened axially relative to the stationary component 154, is adjusted axially, as indicated by axial directional arrow 182, to “close” the clearances formed therebetween the rotating component 152 and the stationary component 154. This adjustment of the rotating component positions each of the short teeth 164 in alignment with one of the long ribs 172 and each of the long teeth 166 in alignment with one of the short ribs 174, thereby closing the radial clearances between the rotating component 152 and the stationary component 154. Turbomachine seal design and the optimal rotor actuation control clearance strategy are obtained via system level optimization.

Referring now to FIG. 11, illustrated are configurations of varying seal designs, and more particularly a design representative of a flowpath seal 200, an inlet endpacking seal 202 and an exhaust endpacking seal 204, each showing seal configuration during varying states of operation, including cold start 205, long rotor, 206, steady 207 and short rotor 208. More specifically, illustrated is a flowpath seal 200, such as that previously described. In addition, illustrated are endpacking seals 202 and 204 in which the plurality of long ribs, such as long ribs 172 and short ribs, such as short ribs 174, may be configured in a non-alternating relationship. In addition, the teeth and/or cooperating ribs and grooves may be formed on both the rotating and stationary components. In the illustrated asymmetric seal configurations, a reduced seal axial span may exist, in comparison to a baseline or symmetric design described herein.

The various embodiments of the exemplary seal design allows for increased turbomachine performance along with greater operational flexibility by enabling active clearance management that reduces the likelihood of seal rubs which would result in increased leakage. The reduction in steady state clearances, results in a significant increase in simple cycle efficiency, without an increase in the footprint of the turbomachine. In addition, the novel seal design and actuation control clearance strategy may result in a reduction in rubs, leading to greater reliability, lowering of fuel costs, a more compact design with up to a 10% reduction in sealing span for steam turbines (ST), reduced maintenance outages, and cost savings over abradables, brush seals, or other known sealing technologies.

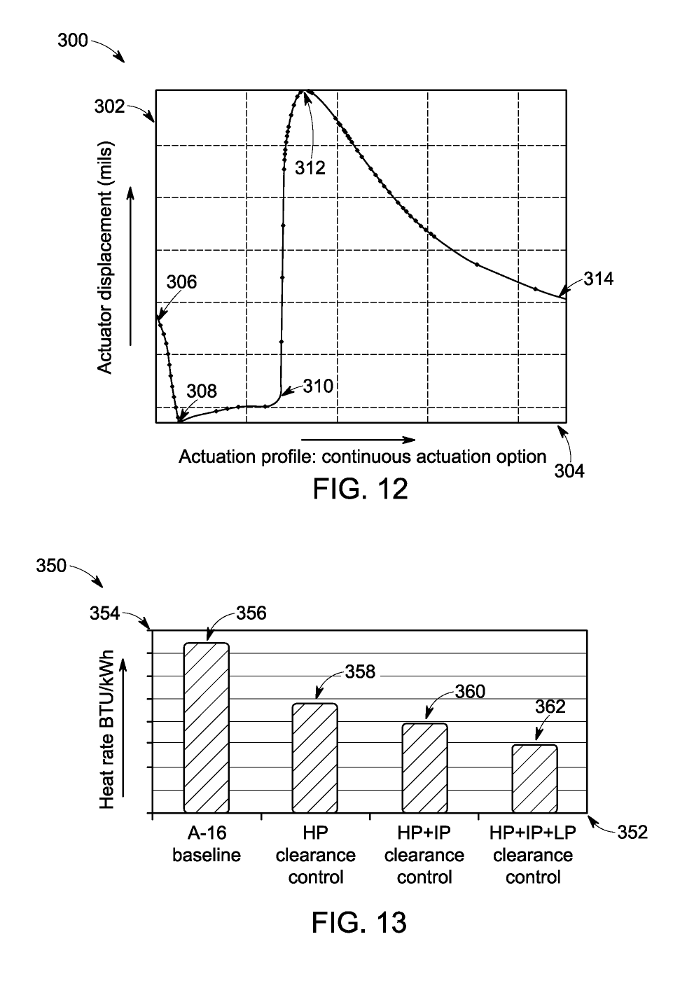

Referring now to FIG. 12, illustrated in an exemplary graphical representation, generally referenced 300, is the effect of actuator displacement as it relates to the actuation profile of a seal design and active clearance control strategy in accordance with an embodiment. More specifically, graph 300 illustrates an actuation profile in accordance with an embodiment illustrating the actuator axial displacement (plotted in axis 302) with the actuation profile (plotted in axis 304).

At a first position, 306, zero actuation or cold assembly is illustrated. At a position 308, as the rotating component is subjected to thermal expansion and a long rotating component condition is met, the rotating component can be adjusted axially towards the thrust bearing, i.e. about 200 mils. At a position 310, at a point in time where steady state operation is reached, the rotor can be adjusted minimally in an axial direction to achieve clearance closure. The turbine is allowed to operate at that point. When the turbine is shut down, the rotating component is axial adjusted, as illustrated at position 312, to a position away from the starting position, 306. The rotating component is gradually adjusted, or pulled, back axially toward the home position 306, at position 314, as the rotating component cools down.

Referring now to FIG. 13, illustrated in an exemplary graphical representation, generally referenced 350, are benefits achieved with use of the seal design and active clearance control strategy in accordance with an embodiment. More specifically, illustrated in FIG. 13 is an example of the benefit achievable through the implementation of active clearance control (ACC) such as described herein, for an A-16 rotary machine. More specifically, graph 350 illustrates various implementation strategies in accordance with embodiments disclosed herein (plotted in axis 352) with the benefit measured in a decrease in the heat rate (plotted in axis 354).

A heat rate for a baseline A-16 rotary machine having no implementation of the seal design and actuation control clearance strategy as disclosed herein, is shown at bar 356. When the seal design and actuation control clearance strategy as disclosed herein is implemented in the high-pressure (HP) section, as shown at bar 358, the heat rate is decreased. Implementing the seal design and actuation control clearance strategy as disclosed herein in both HP and intermediate pressure (IP) sections of the exemplary A-16 rotary machine brings the heat rate down even further, as indicated at bar 360. Implementing the seal design and actuation control clearance strategy as disclosed herein in the HP, IP and low-pressure (LP) sections of the exemplary A-16 rotary machine brings the heat rate down below that of bar 360, as indicated at bar 362. In an embodiment, this amounts to an approximate 0.3% point improvement in efficiency, or 1.3 MW of additional power generation, and may result in an approximate cost benefit of $1.82 MM.

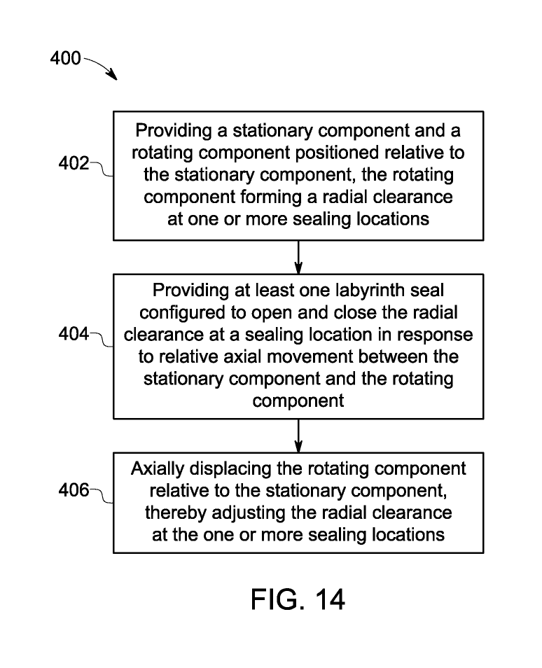

Referring now to FIG. 14, illustrated in a schematic block diagram is of an actuation control clearance strategy 400, or method or operating a turbomachine, to effect relative motion between at least one rotating component and at least one stationary component of a turbomachine using active elements, according to an exemplary embodiment. As illustrated, in a first step 402, a stationary component having an inner wall and a rotating component positioned relative to the stationary component are provided. The rotating component forming a radial clearance at one or more sealing locations between the rotating component and the inner wall. Next, in step 404, at least one labyrinth seal is provided including a plurality of features configured to open and close the radial clearance at a sealing location of the one or more sealing locations in response to relative axial movement between the stationary component and the rotating component. Finally, at step 406, the rotating component is axially displaced relative to the stationary component, thereby adjusting the radial clearance at the one or more sealing locations between the rotating component and the inner wall to suit a given operating condition of the turbomachine.

The labyrinth seal design and actuation control clearance strategy disclosed herein includes a plurality of features configured to open and close radial clearances in response to relative axial movement between a stationary component and a rotating component.

According to embodiments, the exemplary labyrinth seal design and actuation control clearance strategy may be disposed with the teeth and cooperating grooves on either the rotating component or the static component. The location of the ribs and the grooves are designed the such that the same rotor actuation opens or closes the clearances for all seals regardless of whether the teeth are on the rotor or the stator.

It is understood that not necessarily all such objects or advantages described above may be achieved in accordance with any particular embodiment. Thus, for example, those skilled in the art will recognize that the systems and techniques described herein may be embodied or carried out in a manner that achieves or optimized one advantage or group of advantages as taught herein without necessarily achieving other objects or advantages as may be taught or suggested herein.

The foregoing has described a novel seal design and actuation control clearance strategy for active clearance control and span reduction in turbomachines. While the present disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out the disclosure. It is, therefore, to be understood that the appended claims are intended to cover all such modifications and changes as fall within the true spirit of the disclosure.

What is claimed is:

1. A labyrinth seal design for a turbomachine comprising a plurality of features configured to open and close radial clearances in response to relative axial movement between a stationary component and a rotating component.

2. The labyrinth seal design of claim 1, wherein the rotating component is a rotor.

3. The labyrinth seal design of claim 1, wherein the stationary component is a stator.

4. The labyrinth seal design of claim 1, wherein the labyrinth seal design is configured having an arcuate seal element extending from at least one of the rotating component or the stationary component, a plurality of radial extending long teeth extending therefrom the arcuate seal element, and a plurality of radial extending short teeth extending therefrom the arcuate seal segment, wherein the long teeth and the short teeth are configured in one of an alternating relationship or a non-alternating relationship.

5. The labyrinth seal design of claim 4, wherein the labyrinth seal design is further configured to include a plurality of radial extending short ribs and a plurality of radial extending long ribs extending from at least one of the other one of the rotating component or the stationary component, and a plurality of first grooves and a plurality of second grooves configured between a pair of the radial extending long ribs, each of the first grooves and the second grooves, configured between a pair of long ribs, further having a short rib configured therebetween.

6. The labyrinth seal design of claim 5, wherein first groove and the second groove each have an axial dimensional width greater than zero.

7. The labyrinth seal design of claim 6, wherein the first groove and the second groove have equal axial dimensional widths.

8. The labyrinth seal design of claim 6, wherein the first groove and the second groove have unequal axial dimensional widths.

9. The labyrinth seal design of claim 5, wherein one of the first groove and the second groove has an axial width dimension equal to zero and the other of the first groove and the second groove has an axial dimensional width greater than zero.

10. The labyrinth seal design of claim 1, wherein the relative axial movement between the stationary component and the rotating component includes one or more axial movements of the rotating component to effect displacement of the rotating component axially relative to the stationary component and provide radial closure of the features configured to open and close the radial clearances.

11. An actuation control clearance strategy to effect relative motion between at least one rotating component and at least one stationary component of a turbomachine using active elements, comprising:
providing a stationary component having an inner wall and a rotating component positioned relative to the stationary component, the rotating component forming a radial clearance at one or more sealing locations between the rotating component and the inner wall;
providing at least one labyrinth seal including a plurality of features configured to open and close the radial clearance at a sealing location of the one or more sealing locations in response to relative axial movement between the stationary component and the rotating component; and
axially displacing the rotating component relative to the stationary component, thereby adjusting the radial clearance at the one or more sealing locations between the rotating component and the inner wall to suit a given operating condition of the turbomachine.

12. The actuation control clearance strategy of claim 11, wherein the rotating component is a rotor.

13. The actuation control clearance strategy of claim 11, wherein the stationary component is a stator.

14. The actuation control clearance strategy of claim 11, wherein the labyrinth seal is configured having:
an arcuate seal element extending from at least one of the rotating component or the stationary component, a plurality of radial extending long teeth extending therefrom the arcuate seal element, and a plurality of radial extending short teeth extending therefrom the arcuate seal element, wherein the long teeth and the short teeth are configured in one of an alternating relationship or a non-alternating relationship; and
a plurality of radial extending short ribs and a plurality of radial extending long ribs extending from at least one of the other one of the rotating component or the stationary component, and a plurality of first grooves and a plurality of second grooves configured between a pair of the radial extending long ribs, each of the first grooves and the second grooves, configured between a pair of long ribs, further having a short rib configured therebetween.

15. The actuation control clearance strategy of claim 14, wherein first groove and the second groove each have an axial dimensional width greater than zero.

16. The actuation control clearance strategy of claim 14, wherein one of the first groove and the second groove has an axial dimensional width equal to zero and the other of the first groove and the second groove has an axial dimensional width greater than zero.

17. The labyrinth seal design of claim 14, wherein the relative axial displacement between the stationary component and the rotating component includes one or more axial movements of the rotating component to effect displacement of the rotating component axially relative to the stationary component and provide radial closure of the features configured to open and close the radial clearances.

18. A method of operating a turbomachine, comprising:
providing a turbomachine with a stationary component having an inner wall and a rotating component positioned relative to the stationary component, the rotating component carrying a plurality of blades each having a blade tip facing towards the inner wall and forming a radial clearance between each blade tip and the inner wall;
providing a labyrinth seal including a plurality of features configured to open and close the radial clearance in response to relative axial displacement between the stationary component and the rotating component; and
axially displacing the rotating component relative to the stationary component, thereby adjusting the radial clearance between the blade tip and the inner wall to suit a given operating condition of the turbomachine.

19. The method of claim 18, wherein the rotating component is a rotor and the stationary component is a stator.

20. The method of claim 18, wherein the labyrinth seal is configured having:
an arcuate seal element extending from at least one of the rotating component or the stationary component, a plurality of radial extending long teeth extending therefrom the arcuate seal element, and a plurality of radial extending short teeth extending therefrom the arcuate seal segment, wherein the long teeth and the short teeth are configured in one of an alternating relationship or a non-alternating relationship; and
a plurality of radial extending short ribs and a plurality of radial extending long ribs extending from at least one of the other one of the rotating component or the stationary component, and a plurality of first grooves and a plurality of second grooves configured between a pair of the radial extending long ribs, each of the first grooves and the second grooves, configured between a pair of long ribs, further having a short rib configured therebetween.

21. The method of claim 20, wherein first groove and the second groove each have an axial dimensional width greater than zero.

22. The method of claim 20, wherein one of the first groove and the second groove has an axial dimensional width equal to zero and the other of the first groove and the second groove has an axial dimensional width greater than zero.
